(19) United States
(12) Patent Application Publication
(10) Pub. No.: US 2026/0095301 A1
(43) Pub. Date: Apr. 2, 2026

(54) EFFICIENT FUNCTIONAL BOOTSTRAPPING FOR HOMOMORPHIC ENCRYPTION

(71) Applicant: Duality Technologies, Inc., Maplewood, NJ (US)

(72) Inventors: Andreea ALEXANDRU, Weehawken, NJ (US); Yuriy POLYAKOV, Fair Lawn, NJ (US)

(73) Assignee: Duality Technologies, Inc., Maplewood, NJ (US)

(21) Appl. No.: 19/338,066

(22) Filed: Sep. 24, 2025

Related U.S. Application Data
(60) Provisional application No. 63/699,885, filed on Sep. 27, 2024.

(51) Int. Cl. H04L 9/00; G06F 9/4401

(52) U.S. Cl. CPC H04L 9/008; G06F 9/4401

(57) ABSTRACT

End-to-end cryptographic communication to securely exchange data to/from a homomorphic cryptography circuit. The homomorphic cryptography circuit may perform homomorphic operations on ciphertext(s) of plaintext message(s) that evaluate non-linear operation(s) over the encryption of the plaintext message(s) using lookup table(s) under a functional bootstrapping scheme. The functional bootstrapping executes the lookup table(s) using Nth-order trigonometric Hermite interpolation with derivative constraints set to reduce noise for (p) interpolation points, thereby achieving the desired noise refreshing effect of bootstrapping. The homomorphic cryptography circuit may use a vector data structure to amortize the functional bootstrapping by performing the trigonometric Hermite interpolation over a vector of a plurality of the ciphertexts in parallel, e.g., using SIMD instructions, thereby improving the functional bootstrapping efficiency. The circuit output(s) may be decrypted by an external device to generate unencrypted result(s) of the homomorphic operation(s) on the plaintext message(s) with no access to the unencrypted plaintext message(s) themselves.

### CROSS-REFERENCE TO RELATED APPLICATIONS

This application claims the benefit of and priority to U.S. Provisional Patent Application No. 63/699,885 filed Sep. 27, 2024, which is owned by the assignee of the instant application and incorporated herein by reference in its entirety.

### GOVERNMENT LICENSE RIGHTS

This invention was made with government support under Agreement No.: HR00112190003 awarded by the Defense Advanced Research Projects Agency (DARPA). The government has certain rights in the invention.

### FIELD OF THE INVENTION

Embodiments of the invention are directed to data privacy, security, and encryption of secret data. In particular, embodiments of the invention are directed to cryptographic communication to safely share homomorphically encrypted secret data with an external or third party, for secure external execution of homomorphic operations, only on the encrypted secure data, without decrypting and exposing the underlying unencrypted secret data. Embodiments of the invention provide a new cryptographic circuit to securely execute arbitrary homomorphic operations using functional bootstrapping with improved speed and accuracy.

### BACKGROUND OF THE INVENTION

Securely executing complex operations on encrypted data, such as advanced statistical computations for machine learning training and inference, depends on the ability to perform a toolkit of operations over the encrypted data. Current state-of-the-art fully homomorphic encryption scheme (FHE) schemes, such as Brakerski/Fan-Vercauteren (BFV), Brakesrki-Gentry-Vaikuntanathan (BGV) or Cheon-Kim-Kim-Song (CKKS), can perform linear operations and evaluate smooth functions, amortized over many values (applying operations over multiple ciphertexts simultaneously); however, such FHE schemes cannot efficiently evaluate discontinuous (arbitrary) functions. Instead, discontinuous functions such as comparisons, argmin, or S-box are conventionally computed by evaluating look-up tables (LUTs) using the functional bootstrapping available in the Ducas-Micciancio (DM/FHEW)/Chilotti-Gama-Georgieva-Izabachène (CGGI/TFHE) FHE schemes. However, these FHE schemes can only support very small precision (practically limited to 8 bits) and do not support amortized evaluation.

Accordingly, there is a longstanding need in the art for an FHE scheme that can support accurate and efficient functional bootstrapping for arbitrary and amortized look-up table evaluation. Additionally, there is a longstanding need in the art for such an FHE scheme that can support multi-precision plaintexts to execute operations on encryptions thereof such as multi-precision comparisons.

### SUMMARY OF THE INVENTION

To overcome the aforementioned problems inherent in the art, embodiments of the invention provide a new cryptographic circuit comprising functional bootstrapping for arbitrary homomorphic operations using trigonometric Hermite interpolation to reduce noise. Trigonometric Hermite interpolation achieves functional bootstrapping by imposing boundary conditions (e.g., Nth order constraints) that reduce noise around fixed-point inputs (e.g., N input nodes) being interpolated. The new cryptographic circuit may also improve the efficiency and speed of the homomorphic operations by providing amortized functional bootstrapping operating simultaneously over multiple ciphertexts, for example, using SIMD LUT evaluations in a vectorized FHE scheme, such as, CKKS. This amortized circuit operating over vectorized FHE accelerates functional bootstrapping by 2-3 orders of magnitude as compared to a conventional (non-amortized) circuit operating over a scalar FHE scheme, e.g., CGGI. Experimental results for an example 8-bit LUT evaluation achieve an amortized time (e.g., vectorized size/latency of bootstrapping) of 0.72 milliseconds, which is three orders of magnitude faster than the DM/CGGI approach and 6.8× faster than (a more restrictive) amortized functional bootstrapping method based on the Brakerski/Fan-Vercauteren (BFV) FHE scheme. In various embodiments, this new cryptographic circuit may be used to execute operations including multi-precision digit extraction and/or sign evaluation, all at improved accuracy and efficiency.

According to some embodiments of the invention, a device, system, method is provided for secure cryptographic communication between a first computer terminal (e.g., 140 or 110 of FIG. 1) and a second computer terminal (e.g., 150 or 110 of FIG. 1) over a communication channel (e.g., 120 of FIG. 1). The first computer terminal may encrypt and send the second computer terminal one or more ciphertext(s) ct of one or more plaintext message(s) m (without exposing the unencrypted message(s) m themselves to the second computer terminal) under an FHE-LWE scheme (e.g., LWE, Ring LWE, BFV, etc.). The second computer terminal may execute a homomorphic cryptography circuit (e.g., FIG. 2) performing homomorphic operations on the ciphertext(s) ct that evaluates one or more non-linear operation(s) (e.g., 206 and 212 of FIG. 2) over the encryption of the plaintext messages m using one or more lookup tables (LUTs) under a functional bootstrapping scheme (e.g., CKKS, BFV, RGSW, etc.). The homomorphic cryptography circuit may perform functional bootstrapping by executing the LUTs using Nth-order trigonometric Hermite interpolation with derivative constraints set to reduce noise for a set of (p) interpolation points (e.g., the 1-Nth derivatives set to zero), thereby improving the functional bootstrapping accuracy. The homomorphic cryptography circuit may use a vector data structure to amortize the functional bootstrapping by performing the trigonometric Hermite interpolation over a vector of a plurality of the ciphertexts in parallel, e.g., using Single-Instruction-Multiple-Data (SIMD) instructions, thereby improving the functional bootstrapping efficiency. The homomorphic cryptography circuit may further support multi-precision evaluations (e.g., sign evaluation and digit extraction) by breaking down full ciphertexts (e.g., having relatively large modulus Q) into multiple individual digits (e.g., each having relatively smaller modulus q<Q) and performing functional bootstrapping on each digit individually. This further improves efficiency because functional bootstrapping on individual reduced modulus digits uses smaller-size LUTs compared to the relatively large LUTs used for the original large modulus ciphertext. The second computer terminal may send the output(s) ct′ of those homomorphic operations back to the first computer terminal or to a different computer terminal, which may decrypt those output(s) to generate the unencrypted homomorphic operation(s) on the plaintext message(s) m (with no access to the unencrypted plaintext message(s) m).

According to some embodiments of the invention, a new cryptographic circuit is provided for functional bootstrapping in vectorized FHE schemes to perform trigonometric interpolation for arbitrary look-up tables that are efficiently evaluated homomorphically. Embodiments of the invention also provide new efficient homomorphic digit extraction and evaluation of the step function, and homomorphic computation of the sign of a large plaintext that is coefficient-encoded. Such embodiments provide an end-to-end cryptographic circuit for efficient vectorized FHE schemes with fixed-point inputs that supports arbitrary function evaluation. Some embodiments of the invention provide:
Amortized Functional Bootstrapping of (R)LWE ciphertexts using vectorized FHE schemes, such as, CKKS.
Amortized Multi-precision Digit Extraction and Sign Evaluation for (R)LWE Ciphertexts.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system operating a cryptography circuit to execute FHE functional bootstrapping for trigonometric Hermite interpolation, according to an embodiment of the invention;

FIG. 2 schematically illustrates a cryptography circuit to execute multi-precision sign evaluation using functional bootstrapping based on trigonometric Hermite interpolation, according to an embodiment of the invention; and

FIG. 3 is a flowchart of a method for operating a cryptography circuit to execute FHE functional bootstrapping for trigonometric Hermite interpolation, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

Embodiments of the invention provide a new cryptographic circuit implementing FHE functional bootstrapping with improved accuracy using trigonometric Hermite interpolation to evaluate arbitrary (e.g., non-polynomial) homomorphic operations on encrypted data. This cryptographic circuit evaluates any LUT using trigonometric Hermite interpolation that imposes Nth order boundary conditions (e.g., null Nth derivatives) on the N fixed-point inputs (e.g., N nodes) that reduces noise around those inputs. By reducing interpolation noise, the circuit output—an operation on the encrypted data—is closer to an encryption of the (same or equivalent) operation on the plaintext message, thus improving accuracy without exposing that plaintext message. This new cryptographic circuit may also use a vectorized FHE scheme for amortized functional bootstrapping to simultaneously evaluate look-up tables in parallel for multiple ciphertexts, accelerating functional bootstrapping by 2-3 orders of magnitude compared to a non-amortized (non-parallelized, sequential) circuit.

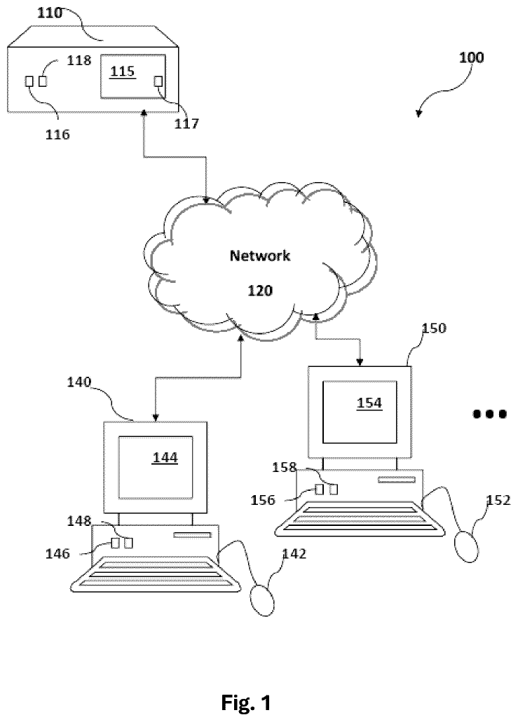

Reference is made to FIG. 1, which schematically illustrates a system 100 operating a cryptography circuit to execute FHE functional bootstrapping based on trigonometric Hermite interpolation, according to an embodiment of the invention. Embodiments of the invention may be executed using any single or combination of devices and/or components of system 100 of FIG. 1. The devices of system 100 may be operated by one or more parties including one or more (e.g., client) computer(s) 140, 150, . . . , and one or more remote (e.g., host) server(s) 110. System 100 devices may store and transmit encrypted data therebetween to internally operate thereon without revealing the underlying unencrypting data. Any or all of system 100 devices including server(s) 110 and/or computer(s) 140, 150, . . . , may be connected via one or more network(s) 120. Network 120 may be any public or private network such as the Internet. Access to network 120 may be through wire line, terrestrial wireless, satellite or other systems well known in the art. Secure party devices may operate on unencrypted data, while insecure parties typically operate only on the encrypted (but not unencrypted) data. Secure party devices may each securely store unencrypted (or encrypted) data, such as, privacy sensitive data, and private keys associated with each dataset, party, etc. Insecure parties may not access other parties' unencrypted data or private keys.

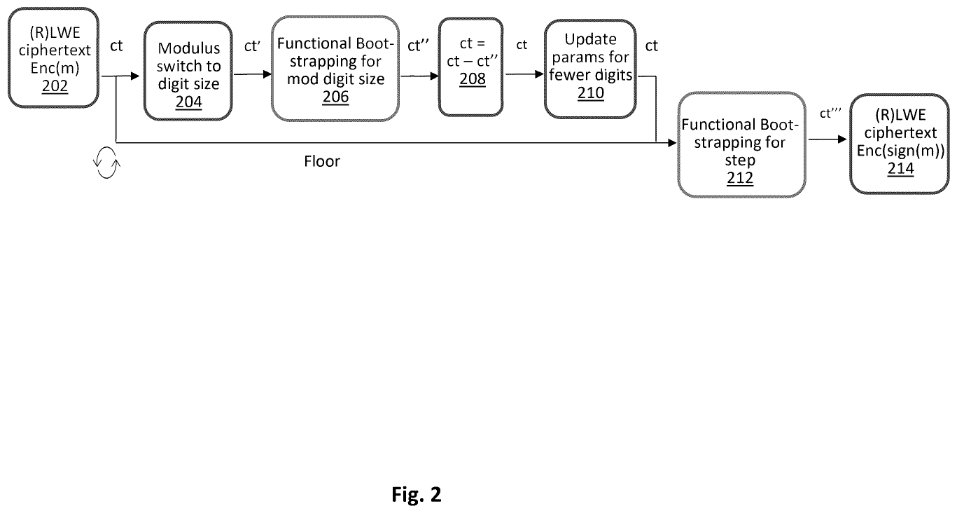

In one embodiment, system 100 may provide secure cryptographic communication between a first computer terminal (e.g., 140 or 110 of FIG. 1) and a second computer terminal (e.g., 150 or 110 of FIG. 1) over a communication channel (e.g., 120 of FIG. 1). The first computer terminal may encrypt and send the second computer terminal one or more ciphertext(s) ct of one or more plaintext message(s) m under an FHE-LWE scheme (e.g., LWE, Ring LWE, BFV, etc.) without exposing the unencrypted message(s) m themselves to the second computer terminal. The second computer terminal may execute a homomorphic cryptography circuit (e.g., FIG. 2) performing homomorphic operations on the ciphertext(s) ct that evaluates one or more non-linear operation(s) over the encryption of the plaintext messages m using one or more lookup tables (LUTs) under a functional bootstrapping scheme (e.g., CKKS, BFV, RGSW, etc.). The homomorphic cryptography circuit may perform functional bootstrapping by executing the LUTs using Nth-order trigonometric Hermite interpolation with derivative constraints (e.g., setting the 1-Nth derivatives set to zero) that reduce noise for a set of (p) interpolation points, thereby improving the functional bootstrapping accuracy. The homomorphic cryptography circuit may use a vector data structure to amortize the functional bootstrapping by performing the trigonometric Hermite interpolation over a vector of a plurality of the ciphertexts in parallel, e.g., using Single-Instruction-Multiple-Data (SIMD) instructions, thereby improving the functional bootstrapping efficiency.

A cryptographic communication system 100 may securely exchange encrypted data between first computer 140 (or 110) and second computer 150 (or 110). The first computer may store one or more unencrypted plaintext private data message and one or more encryption keys. The first computer may use the encryption key to encrypt the plaintext messages to generate one or more FHE ciphertexts. The first computer may then transmit the FHE ciphertexts to the second computer over a communication channel of network 120. The second computer, without access to the decryption key, may execute the cryptographic circuit to accurately and efficiently execute any arbitrary operation (e.g., non-polynomial LUTs such as for searches, comparisons, multi-precision digit extraction, sign evaluation, machine learning training and/or inference, etc.) on the ciphertexts using FHE functional bootstrapping for trigonometric Hermite interpolation, without exposing the underlying plaintext data. Improved computational efficiency at the second computer may increase the speed of network 120 communication to subsequent downstream computer terminals. This transmission between the first and second computers and computation at the second computer may be repeated and iterated for any number of N computers or server(s) 110 throughout a network 120.

Remote computation server 110 may comprise a database 115 to store software processes or applications for storing and retrieving data 117 such as encrypted data (generated by computer(s) 140, 150 encrypting privacy sensitive data) and/or computations to implement embodiments of the invention (e.g., functional bootstrapping for trigonometric Hermite interpolation and/or amortized functional bootstrapping). Database 115 may include one or more outsourced databases internal or external to one or more of server(s) 110 and may be connected thereto by a local or remote and a wired or wireless connection. In alternate embodiments, data 117 may be stored in an alternate location separate from database 115, e.g., memory unit(s) 118.

Computers 140 and 150 may be servers, personal computers, desktop computers, mobile computers, laptop computers, and notebook computers or any other suitable device such as a cellular telephone, personal digital assistant (PDA), video game console, etc., and may include wired or wireless connections or modems. Computers 140 and 150 may include one or more input devices 142 and 152, respectively, for receiving input from a user (e.g., via a pointing device, click-wheel or mouse, keys, touch screen, recorder/microphone, other input components). Computers 140 and 150 may include one or more output devices 144 and 154 (e.g., a monitor or screen) for displaying data to a user provided by or for server(s) 110.

Network 120, which connects server(s) 110 and computers 140 and 150, may be any public or private network such as the Internet. Access to network 120 may be through wire line, terrestrial wireless, satellite or other systems well known in the art.

Server(s) 110 and computers 140 and 150, may include one or more controller(s) or processor(s) 116, 146, and 156, respectively, for executing operations according to embodiments of the invention and one or more memory unit(s) 118, 148, and 158, respectively, for storing data (e.g., public and/or private keys in memory unit(s) 148, and 158, encrypted privacy sensitive data in memory unit(s) 118, software for applying computations or calculations according to embodiments of the invention in memory unit(s) 118, etc.) executable by the processor(s). Processor(s) 116, 146, and/or 156 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 118, 148, and/or 158 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

Reference is made to FIG. 2, which schematically illustrates a cryptography circuit to execute multi-precision sign evaluation using functional bootstrapping based on trigonometric Hermite interpolation, according to an embodiment of the invention. FIG. 2 depicts an example circuit for (R)LWE FHE (supporting linear operations) and CKKS (for functional bootstrapping) to execute a multiprecision sign evaluation. Computationally intensive functional bootstrapping only occurs in operations 206 and 212; all other operations are computationally negligible linear operations. Operation 204 corresponds to line 2 of Algorithm 2 (switching to digit size). Operation 206 corresponds to line 3 of Algorithm 2 (functional bootstrapping for the modular reduction function). Operation 208 subtracts the least significant digit and corresponds to line 4. Operation corresponds to lines 4 and 5 of Algorithm 3 (note that Algorithm 2 is called as a subroutine in Algorithm 3). Operation 212 is the final LUT evaluation in Algorithm 3.

### FHE Schemes and Bootstrapping

“Bootstrapping” converts an “exhausted” ciphertext (having relatively high and/or above-threshold noise preventing further homomorphic operations to be performed on it) to a an equivalent “refreshed” ciphertext (having relatively low and/or below-threshold noise enabling further homomorphic operations to be performed on it). “Functional” a.k.a. “programmable” bootstrapping additionally or alternatively evaluates a function or program operation executed on the encrypted message during the bootstrapping operation. The output ciphertext of functional bootstrapping encrypts the function of the plaintext message rather than the message itself, in addition to reducing the noise in the input ciphertext. Embodiments of the invention use trigonometric Hermite interpolation to reduce the noise of functional bootstrapping thus generating refreshed ciphertexts that can support more homomorphic operations before the next bootstrapping operation is invoked.

Embodiments of the invention implement a combination of FHE learning with errors (LWE) schemes, such as Ring LWE, for linear homomorphic encryption, and FHE functional bootstrapping schemes, such as, BFV, RGSW, BGV, and CKKS, for trigonometric Hermite interpolation evaluation. Various example combinations include, but are not limited to:
1. Ring LWE or RLWE (linear)+CKKS (functional bootstrapping)
2. LWE (linear)+CKKS (functional bootstrapping)
3. RLWE (linear)+BFV (functional bootstrapping)
4. LWE (linear)+RGSW (functional bootstrapping)

In general, embodiments of the invention referring to specific types of FHE-LWE schemes (e.g., Ring LWE, FHEW, TFHE, etc.) can be generalized to any or different FHE-LWE schemes. Likewise, embodiments of the invention referring to specific types of FHE-functional bootstrapping schemes (e.g., CKKS, BFV, RGSW, etc.) can be generalized to any or different types of FHE-functional bootstrapping schemes that can evaluate trigonometric Hermite interpolations. FHE-LWE (linear) and/or functional bootstrapping (non-linear) schemes may be vectorized to enable amortized operations over multiple ciphertexts simultaneously (e.g., using SIMD parallelization). Details of the non-limiting example 1. RLWE (linear)+CKKS (functional bootstrapping) is described below for demonstrative purposes only and can readily be adapted to encompass other disclosed encryption schemes.

### (Ring) Learning With Errors ((R)LWE) Encryption

Standard (public-key) Regev-like encryption secure under the Learning with Errors (LWE) hardness assumption can be used as an input for functional bootstrapping. Sample A from

$${Z}_{Q}^{m \times n} ,$$

sample an error e₁ from

$${𝒳}_{e}^{n} ,$$

and sample the secret key sk=s from χⁿ (for χ, χₑ special distributions), then set the public key pk=(A,t=A·s+e₁). To encrypt the message m∈Zₚ, sample r, e₂, e₃ from χ^{m},

$${𝒳}_{e}^{m} ,$$

χₑ respectively, and set the LWE ciphertext e.g. as:

$$ct = ( {a}^{T} , b ) = ( {r}^{T} \cdot A + {e}_{2}^{T} , {r}^{T} t + {e}_{3} + ⌈ \frac{Q}{p} ⌋ \cdot m mod Q ) .$$

The decryption first computes v=b−a^{τ}·s, then retrieves the message as

$$⌈ \frac{p}{Q} \cdot v ⌋ mod p ,$$

which returns the correct value as long as the parameters satisfy the correctness requirements.

Secret key encryption can also be used instead of public key encryption. In this case, the LWE ciphertext may be computed, e.g., as:

$$ct = ( {a}^{T} , b ) = ( {u}^{T} , {u}^{T} + {e}_{1} + ⌈ \frac{Q}{p} ⌋ \cdot m mod Q ) ,$$

where u is randomly sampled from

$${Z}_{Q}^{m} .$$

An input vector may also be encrypted instead of a scalar at a smaller plaintext-ciphertext expansion by working over higher degree rings. A vector may be identified as m=[m₀ m₁ . . . mₙ₋₁]^{τ}∈Z^{N} with an element of the ring m∈R, m(x)=m₀+m₁·x+ . . . +mₙ₋₁·x^{N}, where N is the ring dimension. Then, the RLWE encryption and decryption from above become e.g.: sample a∈R_{Q}, sample an error e₁∈χ′ₑ, and sample the secret key sk=s∈χ′, then set the public key pk=(a,t=a·s+e₁). To encrypt the message m∈R, sample r, e₂, e₃ from χ, χₑ, χₑ respectively, and set the RLWE ciphertext e.g., as:

$$ct = ( a , b ) = ( r \cdot a + {e}_{2} , r \cdot t + {e}_{3} + ⌈ \frac{Q}{p} ⌋ \cdot m mod Q ) .$$

The decryption first computes v=b−a·s, then retrieves the message as

$$m ( x ) = ⌈ \frac{p}{Q} \cdot v ⌋ mod p$$

and recovers the input vector m from the coefficients of m(x).

When the input vector is encoded as the coefficients of the plaintext polynomial, the encoding may be referred to as “coefficient encoding.” When a transformation (e.g., Number Theoretic Transform or Fast Fourier Transform) is applied on the input vector to generate a polynomial, the encoding may be referred to as “slot encoding.”

### Cheon-Kim-Kim-Song (CKKS) FHE Scheme

The Cheon-Kim-Kim-Song (CKKS) scheme is an approximate homomorphic encryption that supports efficient homomorphic polynomial computations over real and complex numbers. Due to its ability to efficiently evaluate polynomial functions over vectors of real numbers, the CKKS scheme provides a practical solution for many privacy-preserving machine learning applications, significantly outperforming both BGV/BFV and DM/CGGI. From the throughput perspective, the CKKS scheme also provides the most efficient bootstrapping operation; its optimized variants require e.g. on the order of 10 seconds for bootstrapping 32,768 encrypted real numbers with precision of 15 bits or so. Although the CKKS scheme deviates from prior exact BGV/BFV and DM/CGGI in terms of correctness requirements, CKKS bootstrapping still conceptually uses Gentry's blueprint, i.e., it homomorphically evaluates its own decryption circuit. However, the CKKS scheme does not provide an efficient, robust solution for evaluating discontinuous functions, e.g., sign/comparison, as polynomial approximations of these functions are often complicated by the requirements of knowing the approximation range and achieving desired precision. For this reason, CKKS often uses other schemes, e.g., DM/CGGI, via scheme switching to evaluate discontinuous functions, which is associated with high performance costs.

The CKKS encoding, encryption, decryption and decoding work as follows. Given a (real) vector v∈R^{N/2}, compute m(x):=[τ⁻¹(Δ·v)]∈R as the encoding of v where τ is the canonical embedding on R and Δ is the scaling factor. This encoding is a slot encoding. For a message polynomial m(x)∈R and public key pk, sample v, e₀, e₁ from the appropriate distributions, and return

$$ct := v \cdot pk + ( {e}_{0} , {e}_{1} + m ( x ) ) ∈ {R}_{{Q}_{L}}^{2}$$

as the encryption of m(x). Given

$$ct = ( a , b ) ∈ {R}_{{Q}_{i}}^{2}$$

and the secret key sk:=s, ct is decrypted as \hat{m}(x):=as+b mod Qᵢ. Finally to decode a message m(x)∈R, compute \hat{v}:=τ(m(x))/Δ∈R^{N/2}.

The bootstrapping procedure, which may input a depleted or exhausted ciphertext, returns a refreshed ciphertext with noise close to a newly encrypted ciphertext. The bootstrapping steps are e.g. as follows: raise the modulus through ModRaise, which will pollute the message with overflow, perform homomorphic encoding (going from coefficient encoding to slot encoding) through CtS, evaluate a modular approximation polynomial, through EvalMod1, then perform the homomorphic decoding (to go back from the slot encoding to the coefficient encoding), through StC. Schematically, the encoded messages may change as follows through the bootstrapping procedure:

$$Enc ( Δ m ( x ) mod {Q}_{0} ) ModRaise \to Enc ( Δ m ( x ) + {Q}_{0} I ( x ) mod {Q}_{L} ) CtS \to Enc ( Δ v + {Q}_{0} I mod {Q}_{L} ) EvalMod 1 \to Enc ( Δ v mod {Q}_{l} ) StC \to Enc ( Δ m ( x ) mod {Q}_{l} ) .$$

### Homomorphic Sign Evaluation

A state-of-the-art method to compute the sign of an encrypted value using bootstrapping techniques for the DM/CGGI schemes is described. Embodiments of the invention provide an efficient solution for batch evaluating the sign of the elements of an encrypted vector that make use of this method as a backbone, but replace the DM functional bootstrapping calls with specialized functional (e.g., CKKS) bootstrapping calls.

The input may be the encryption of a numerical value m∈Z, usually a signed integer, or a fractional number in fixed-point, binary, two's complement representation. The input may be presented as an LWE ciphertext, e.g., a vector of elements in Z_{Q}. The message m may be an integer modulo Q/α. It may be assumed e.g. that α=2^{l} and Q=2^{h} are powers of 2, so that the message m can also be interpreted as a (h−l)-bit integer. The problem is to compute an encryption of the most significant bit of m, e.g., └m/2^{h-l-1}┘. If m∈Z₂_{^{h-l}} is the standard (two's complement) representation of a signed integer, this bit is the sign of m, e.g., it equals 1 if and only if m represents a negative number.

The problem is that the complexity of the DM/CGGI bootstrapping procedure (in particular, the size of the DM/CGGI accumulators) is linear in the ciphertext modulus Q. So, while conceptually the sign computation can be performed directly using the DM/CGGI procedure, the resulting algorithm would be terribly inefficient, both in theory (exponential in the bit size of the input) and in practice. To circumvent this problem, the ciphertext modulo Q is “broken down” into multiple digits, each working internally with a much smaller modulus q which enables the use of efficient DM/CGGI bootstrapping. For each digit, a homomorphic floor function is evaluated, which can be used to clear the least significant digit from the ciphertext. As soon as the current least significant digit is cleared, the ciphertext is scaled down using modulus switching from Q to αQ/q. This iterative procedure is repeated until Q becomes less than or equal to q. At that point, efficient DM/CGGI bootstrapping can be used directly to evaluate the sign function. Conceptually, this algorithm corresponds to the “schoolbook” long division algorithm. The main challenge in this long division algorithm is associated with evaluating the floor function, which is not negacyclic and hence cannot be directly evaluated using DM/CGGI bootstrapping.

### CKKS Functional Bootstrapping

Given any operation ƒ(x) to homomorphically evaluate on ciphertexts encrypting x∈Zₚ, embodiments of the invention may implement an amortized version of the DM/CGGI functional bootstrapping, for ciphertexts ct satisfying

$$〈 ct , s 〉 = Δ \frac{m}{p} + e .$$

CKKS bootstrapping is currently the most efficient amortized bootstrapping procedure, although other bootstrapping schemes can be used. Embodiments of the invention aim to remove the overflows by evaluating a polynomial approximating modular reduction over the encoded raised ciphertext—which keeps the scaled message as is but removes the scaled overflows. Since in CKKS we can scale messages m to satisfy m≈sin (m), the modular reduction approximation for modulus q is

$${[ m + qI ]}_{q} = {[ m ]}_{q} = \frac{q}{2 π} sin ( \frac{2 π m}{q} ) .$$

### Trigonometric Interpolations for LUT Evaluation

Some embodiments of the invention interpolate by finding a polynomial approximation for a plurality of fixed-point inputs, e.g., such that,

$$\frac{m}{p} + qI ↦ f ( m )$$

in the points of interest. Towards this end, such embodiments target trigonometric interpolation of the form e.g.:

$$LUT ( x ) = {a}_{0} + {\sum }_{k = 1}^{p - 1} {a}_{k} cos ( 2 π k x ) + {b}_{k} sin ( 2 π kx ) ,$$

which provides periodicity for modular approximation.

However, given that CKKS is an approximate scheme, small errors can push the message away from the points of interest. Therefore, embodiments of the invention provide a smooth approximation function, e.g., which has zero first derivatives in the points of interest.

For a look-up table evaluation with function ƒ:Zₚ→Zₚ, embodiments of the invention may formulate the problem as a square linear system of equations with 2p equations and 2p unknowns

$${( {a}_{k} )}_{k = 0}^{p - 1} , {( {b}_{k} )}_{k = 1}^{p} ,$$

e.g.:

$$LUT ( \frac{0}{p} ) = f ( 0 ) , … , LUT ( \frac{p - 1}{p} ) = f ( p - 1 )$$

$${LUT}^{′} ( \frac{0}{p} ) = 0 , … , {LUT}^{′} ( \frac{p - 1}{p} ) = 0 .$$

This problem represents a linear system of equations that can be numerically solved for coefficients for

$${( {a}_{k} )}_{k = 0}^{p - 1} , {( {b}_{k} )}_{k = 1}^{p - 1}$$

using a linear solver.

Embodiments of the invention can also obtain an analytical expression using a known solution for trigonometric Hermite interpolation. The first-order trigonometric Hermite interpolation with a first order constraint that sets the first derivatives of the interpolation at the set of p interpolation points to zero may be, for example, of the following or equivalent form (e.g. obtained via algebraic/trigonometric transformations from, or numerical approximations of, this expression):

$$R ( x ) = {\sum }_{l = 0}^{p - 1} f ( l ) \cdot U ( 2 π ( x - \frac{l}{p} ) ) , where$$

$$U ( x ) = \frac{1}{p} ( 1 + \frac{2}{p} {\sum }_{k = 1}^{p - 1} ( p - k ) cos ( kx ) ) ,$$

where ƒ(l) is an interpolated function at point l and x is a real number between 0 and 1, to derive the fractional values 0, 1/p, 2/p, . . . , (p−2)/p, (p−1)/p, corresponding to p nodes at the set of p interpolation points and their proximity. This trigonometric series can be transformed to an equivalent form convenient for FHE evaluation, such as power series that can be evaluated using the Paterson-Stockmeyer or Baby-Step-Giant-Step approach.

A solution can also be obtained for the second-order trigonometric Hermite interpolation, e.g., when both first and second derivatives are set to 0, which achieves extra noise reduction. The second-order trigonometric Hermite interpolation with a second order constraint that sets the second derivatives of the interpolation at the set of p interpolation points to zero may be, for example, of the following or equivalent form (e.g. obtained via algebraic/trigonometric transformations from, or numerical approximations of, this expression):

$${R}_{2} ( x ) = {\sum }_{l = 0}^{p - 1} f ( l ) \cdot {U}_{2} ( 2 π ( x - \frac{l}{p} ) ) , where$$

$${U}_{2} ( x ) = U ( x ) + \frac{1 - cos ( p x )}{{p}^{3}} {\sum }_{k = 1}^{⌊ p / 2 ⌋} ( 2 - {γ}_{p , k} ) k ( p - k ) cos ( k x ) ,$$

γ_{p,k}=1 if p is even and k=p/2, and γ_{p,k}=0 otherwise. Here U(x) is the same as above. This trigonometric series can be transformed into an equivalent form convenient for FHE evaluation, such as power series that can be evaluated using the Paterson-Stockmeyer or Baby-Step-Giant-Step approach.

A solution can also be obtained for the third-order trigonometric Hermite interpolation, e.g., when first, second, and third derivatives are set to 0, which achieves further noise reduction. The third-order trigonometric Hermite interpolation with a third order constraint that sets the third derivatives of the interpolation at the set of p interpolation points to zero may be, for example, of the following or equivalent form (e.g. obtained via algebraic/trigonometric transformations from, or numerical approximations of, this expression):

$${R}_{3} ( x ) = {\sum }_{l = 0}^{p - 1} f ( l ) \cdot {U}_{3} ( 2 π ( x - \frac{l}{p} ) ) , where$$

$${U}_{3} ( x ) = U ( x ) + \frac{2 ( 1 - cos ( p x ) )}{3 {p}^{4}} {\sum }_{k = 1}^{p - 1} k ( p - k ) ( 2 p - k ) cos ( k x ) .$$

This trigonometric series can be transformed to an equivalent form convenient for FHE evaluation, such as power series that can be evaluated using the Paterson-Stockmeyer or Baby-Step-Giant-Step approach.

### Amortized Functional Bootstrapping

An FHE-LWE (e.g., Ring LWE) ciphertext, e.g., denoted ct, may encrypt a vector of messages m. Additionally or alternatively, ct may be obtained by packing multiple LWE ciphertexts each encrypting an element of m.

In embodiments where the input ciphertext is in RLWE form, the message is typically encoded in coefficients. Therefore, in such embodiments, the first step in the functional bootstrapping is to apply ModRaise, with both the message and overflows coefficient-encoded. Then, the homomorphic encoding CtS may be applied, which brings both the message and the overflows into the slots domain, ready for the polynomial evaluation as the next step. Note that for full packing, e.g., to bootstrap N values in the coefficients, embodiments of the invention use two CKKS ciphertexts (one representing the real part and one the imaginary part, obtained from conjugating the result of the CtS transform) and run the polynomial evaluation on both, then combine them back into one ciphertext. Finally, to return to the RLWE encoding, embodiments of the invention run the homomorphic decoding StC. In other words, the same bootstrapping blueprint as described above can be used, except for a different polynomial evaluation, which also does function evaluation in this case. For EvalLUT, embodiments of the invention use the trigonometric polynomial R(x), R₂(x), or R₃(x), depending on whether we want to use first-order, second-order, or third-order interpolation. Further, any integer N>3 order interpolation may be used for further noise reduction.

Algorithm 1 below provides an example procedure for amortized functional bootstrapping for a LUT evaluation in CKKS of a ciphertext ct encrypting in RLWE a vector of multiple messages m in parallel:

1 [symbol] lgorithm 2 Amortized functional bootstrapping for an RLWE ciphertext

```
Public parameters:
  - q: input RLWE ciphertext modulus;
  - q′₀: CKKS ciphertext modulus, prime, close to q;
  - Q′ᵢ: raised CKKS ciphertext modulus (used during bootstrapping, where i = 0
    initially);
  - Δ: CKKS scaling factor;
  - Q: output ciphertext modulus;
  - P: output plaintext modulus;
  - p: input RLWE plaintext modulus;
  - Q′: CKKS ciphertext modulus after bootstrapping;
  - LUT: coefficients for the look-up table evaluation.
1: procedure FUNCBT _{q′, Q′L, Δ} (ct ∈ [symbol] _{q}², LUT)
2:  ${ct}_{1} ← ModSwitch ( ct , {q}_{0}^{′} ) ⊳ Switch ct from q to {q}_{0}^{′} . The scaling of the message$
  $becomes \frac{{q}_{0}^{′}}{p} .$
3:  ${ct}_{2} ← \frac{Δ}{{q}_{0}^{′}} {ct}_{1} ⊳ Adjust the scaling factor such that we obtain a typical CKKS$
  $ciphertext encoding Δ \frac{m}{p} mod {q}_{0}^{′} .$
4:  ${ct}_{3} ← ModRaise ( {ct}_{2} , {Q}_{0}^{′} ) ⊳ Encoded vector becomes Δ \frac{m}{p} + {q}^{′} I ( X ) mod {Q}_{0}^{′}$
5: ct₄ ← CtS)(ct₃) [symbol]   Homomorphic encoding operation, the encoded vector
  $becomes Δ \frac{m ( X )}{p} + {q}^{′} I$
6: ct₅ ← EvalLUT(ct₄, LUT). [symbol]   Homomorphically evaluate the trigonometric
  interpolation polynomial LUT). The result will encode Δm′ (X) mod Q′, where m′
  are the coefficients corresponding to the slots of f(m).
7: ct₆ ← StC(ct₅) [symbol]   Homomorphic decoding operation with an adjusting factor of
  ${Q}^{′} / ( Δ QP ) , the encoded vector becomes \frac{{Q}^{′}}{QP} f ( m ) mod {Q}^{′}$
8: ct′ ← ModSwitch(ct₆, Q′) [symbol]   Switch ct₆ from Q to Q′. The RLWE ciphertext
  $encodes \frac{Q}{P} f ( m ) .$
9: return ct′ [symbol]
indicates data missing or illegible when filed
```

Lines 2 and 3 correspond to transforming the RLWE scheme to CKKS (these operations have a negligible performance cost). Lines 4 through 7 invoke a classing CKKS bootstrapping workflow, except that line 6 performs an LUT evaluation instead of computing the identity function as in the case of classical CKKS bootstrapping. Line 8 switches back from CKKS to RLWE (again the performance cost of this step is negligible).

### Multiprecision Comparison Using Functional Bootstrapping

Helper functions: The LUTs used for Multiprecision Comparison are the ones corresponding to the modulo and step functions. Embodiments of the invention follow the approach outlined in the previous section, e.g., deriving the coefficients through solving a linear system of equations.

The relation between the two functions of interest are e.g., as follows. Consider the function (e.g., obtain its periodic version through the trigonometric interpolation) modulo p, Rmodₚ(x)=x mod p for p a power of two. Note Rmodₚ may be defined recursively if Rmodₚ/2 for p>2 and a scaled step function stepₚ is defined e.g., as:

$${step}_{p} ( x ) = \{ 0 if 0 \leq x < 1 / 2$$

$$Namely , p / 2 if 1 / 2 \leq x < 1.$$

$${Rmod}_{p} ( x ) = {Rmod}_{\frac{p}{2}} ( 2 x ) + {Rstep}_{p} ( x ) , p > 2$$

$${Rmod}_{2} ( x ) = {Rstep}_{2} ( x ) = \frac{1}{2} - \frac{1}{2} cos ( 2 π x ) .$$

In the last iteration of the sign algorithm, in order to extract the sign of the most significant digit, embodiments of the invention may use the unscaled Heaviside step function, which is obtained by multiplying the scaled version by

$$\frac{2}{p} .$$

### Multiprecision Sign Evaluation

Algorithms 2 and 3 below provide example procedures for the homomorphic floor evaluation and multiprecision sign evaluation, respectively, using a LUT evaluation in CKKS of a ciphertext ct encrypting a message in RLWE:

2 [symbol] lgorithm 3 Homomorphic floor evaluation for an RLWE ciphertext

```
1:  $procedure {HomFloor}_{P} ( ct ∈ {ℛ}_{Q}^{2} )$
2:  ${ct}_{1} ← ct mod q ⊳ Extract the RLWE digit encrypting a digit in {ℤ}_{p}^{w} .$
3:  ${ct}_{2} ← {FuncBT}_{{q}^{′} , {Q}_{L}^{′} , Δ} ( {ct}_{1} , LUT ( R {mod}_{p} ( x ) ) ) ⊳$
  Perform the functional bootstrapping corresponding to the modulo p function. The
  $returned ciphertext {ct}_{2} encodes \frac{Q}{P} ( m mod p ) .$
4: return ct − ct₂ [symbol]
indicates data missing or illegible when filed
```

3 [symbol] gorithm 4 Multiprecision sign evaluation for an RLWE ciphertext

1: $procedure HomSign ( ct ∈ {ℛ}_{Q}^{2} )$
2: while Q > q do
3: ct₁ ← HomFloorₚ(ct)
4: ct ← ModSwitch(ct₁, Q/p)
5: Q ← Q/p, P ← P/p
$return {FuncBT}_{{q}^{′} , {Q}_{L}^{′} , Δ} ( ct , LUT ( \frac{2}{p} {Rstep}_{p} ( x ) ) )$ [symbol]
indicates data missing or illegible when filed

Overall, Algorithm 3 uses

$$\frac{log ( P )}{log ( p )}$$

CKKS functional bootstrapping procedures, where P is the plaintext modulus of the input RLWE ciphertext and p the plaintext modulus of the digit.

### Multiprecision Digit Extraction

When the cost of computing EvalLUT for a large plaintext modulus directly is relatively high or above threshold, the multiprecision LUT evaluation approach may be used. The high-level idea is to decompose the (R)LWE ciphertexts into digits and then perform (typically different) small-size LUTs against the encrypted digits. Methods for evaluating multiprecision LUT evaluation include tree-based and chain-based methods. The tree-based approach provides a general functionality, e.g., it can evaluate a random-looking LUT such as S-box, but has an exponential complexity. The chaining-based method provides a smaller complexity but for special (more structured) LUTs, e.g., an LUT for a parity function.

Algorithm 4 below provides an example procedure for homomorphic digit decomposition using a LUT evaluation in CKKS of a ciphertext ct encrypting a message in RLWE:

4 [symbol] gorithm 5 Homomorphic digit decomposition for an RLWE ciphertext

1: $procedure HomDigitDecomp ( ct ∈ {ℛ}_{Q}^{2} )$
2: k ← 0
3: while Q > q do
4: ${ct}_{k} ← ct mod q ⊳ Extract the RLWE digit encrypting a digit in {ℤ}_{p}^{w} .$
5: ${ct}_{d} ← {FuncBT}_{{q}^{′} , {Q}_{L}^{′} , Δ} ( {ct}_{k} , LUT ( R {mod}_{p} ( x ) ) )$
6: ct ← ct − ct_{d}
7: ct ← ModSwitch(ct, Q/p)
8: Q ← Q/p, P ← P/p
9: k ← k + 1
return ({ctₖ}_{i∈[k]},ct)

[symbol]

indicates data missing or illegible when filed

Algorithm 4 is similar to Algorithm 3 except for their last “return” steps. In Algorithm 3, the last step evaluates the sign function for the most significant digit (using the step function). However, Algorithm 4 extracts the most significant digit as is. In other words, the last LUT evaluation of Algorithm 3 is not needed in Algorithm 4. Hence, Algorithm 4 has a smaller computational complexity than Algorithm 3.

Overall, Algorithm 4 uses

$$\frac{log ( P )}{log ( p )} - 1$$

CKKS functional bootstrapping procedures, where P is the plaintext modulus of the input RLWE ciphertext and p the plaintext modulus of the digit.

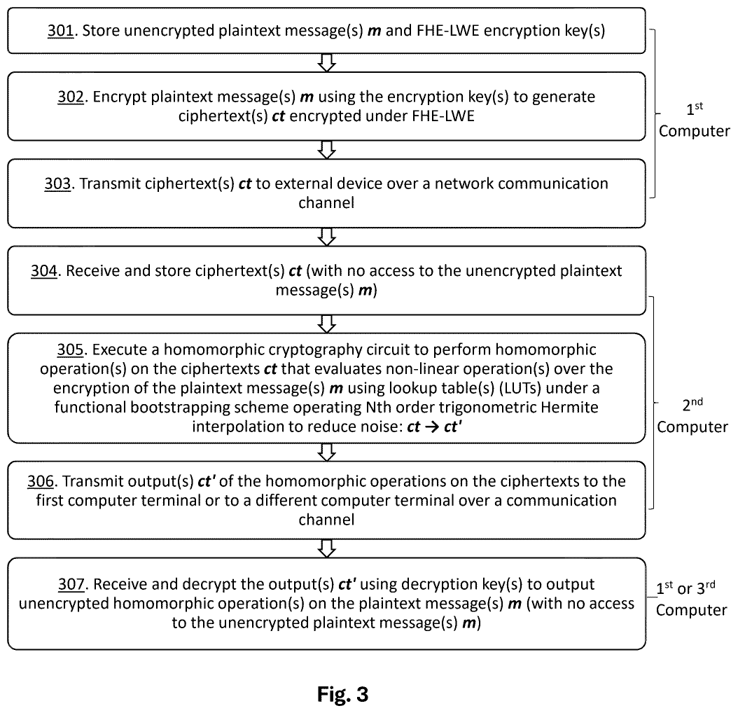

Reference is made to FIG. 3, which is a flowchart of a method for operating a cryptography circuit to execute FHE functional bootstrapping for trigonometric Hermite interpolation, according to an embodiment of the invention. Operations of FIG. 3 may be executed by the hardware of FIG. 1 (e.g., server processor(s) 116, and/or client-side processor(s) 146 and/or 156), data structure of FIG. 2, or other hardware/data structures.

In operation 301, one or more processor(s) of a first computer (e.g., 140 or 110 of FIG. 1) may receive or generate and store one or more unencrypted plaintext message(s) m and one or more FHE-LWE encryption key(s). Any FHE-LWE scheme may be used, for example, LWE, Ring LWE, BFV, etc. The FHE-LWE encryption (public) key(s) in operation 302 may be paired with one or more FHE-LWE decryption (private) key(s) in operation 307 (or other decryption key(s) due to intermediate key switching, transciphering, or re-encryption). In a scenario where the same first computer encrypts (operation 302) and decrypts (operation 307), the first computer may generate and store both the encryption and decryption keys. In a scenario where a different first computer encrypts (operation 302) than a third computer decrypts (operation 307) and the encryption and decryption keys are paired, the third computer may generate both the encryption and decryption keys and send the encryption key to the first computer before operation 301.

In operation 302, the one or more processor(s) of the first computer may retrieve and transform the plaintext message(s) m using the encryption key(s) to generate one or more ciphertexts ct of the plaintext message(s) encrypted under FHE-LWE.

In operation 303, the one or more processor(s) of the first computer may transmit the ciphertexts ct to a second computer terminal (e.g., 150 or 110 of FIG. 1) to establish cryptographic communication over a communication channel (e.g., of network 120 of FIG. 1 or another network).

In operation 304, one or more processor(s) of a second computer may receive and store the one or more ciphertext(s) ct (with no access to the unencrypted plaintext message(s) m).

In operation 305, the one or more processor(s) of the second computer may execute a homomorphic cryptography circuit (e.g., FIG. 2) performing homomorphic operations on the ciphertexts ct that evaluates a non-linear operation (e.g., operations 206 and 212 of FIG. 2) over the encryption of the plaintext messages m using one or more lookup table(s) (LUTs) (without unencrypting the plaintext messages m) under a functional bootstrapping scheme (e.g., CKKS, BFV, RGSW, etc.). This functional bootstrapping (executing LUTs) may use Nth-order trigonometric Hermite interpolation with derivative constraints set to reduce noise for a set of a plurality of p interpolation points to generate. Operation 305 may generate transform ciphertext inputs ct to ciphertext outputs ct′.

In some embodiments, the derivative constraints comprise Nth order constraints to set the 1-Nth derivatives of the set of p interpolation points to zero, for any integer N=1, 2, 3, . . . . A higher Nth order generally reduces more noise than a lower order. The Nth order trigonometric Hermite interpolation with Nth order constraints that sets the 1-Nth derivatives of the interpolation at the set of p interpolation points to zero may be, for example, of the above or equivalent forms R(x), R₂(x) and/or R₃(x) (e.g. obtained via algebraic/trigonometric transformations from, or numerical approximations of, these expressions). Other or additional equations for the order trigonometric Hermite interpolation may also be used.

Operation 305 may be parallelized over multiple ciphertexts to improve efficiency. In some embodiments, the homomorphic cryptography circuit uses a vector data structure to amortize the functional bootstrapping by performing the trigonometric Hermite interpolation over a vector of a plurality of the ciphertexts in parallel. In an embodiment, the one or more processor(s) may execute a Single-Instruction-Multiple-Data (SIMD) instruction to perform the trigonometric Hermite interpolation over the vector of ciphertexts in parallel.

In one embodiment, the homomorphic cryptography circuit may execute functional bootstrapping to evaluate multi-precision sign evaluation (e.g., Algorithm 3 calling Algorithm 2). Such as homomorphic cryptography circuit may break down or divide the ciphertexts ct (e.g., having relatively large modulus Q) into multiple individual digits (e.g., each having relatively smaller modulus q<Q). For each digit, the homomorphic cryptography circuit may iteratively execute functional bootstrapping (e.g., the homomorphic floor function in Algorithm 3 line 3, calling Algorithm 2) to clear the least significant digit from the ciphertexts until only the most significant digit remains. Functional bootstrapping each smaller modulus digit individually uses a smaller-size LUT for the homomorphic floor function compared to a single relatively large LUT used for the full ciphertext, thereby signifyingly improving functional bootstrapping efficiency. After all least significant digits are cleared from the ciphertexts, the homomorphic cryptography circuit may execute an additional functional bootstrapping operation (e.g., the sign evaluation in Algorithm 3's return line) on only the remaining most significant digit. This sign evaluation is also executed on a reduced modulus digit that uses a smaller-size LUT compared to the relatively large LUT used for the original large modulus ciphertext, thereby further increasing the sign evaluation efficiency.

In another embodiment, the homomorphic cryptography circuit may execute functional bootstrapping to evaluate multi-precision digit extraction (e.g., Algorithm 4). Such as homomorphic cryptography circuit may break down or divide the ciphertexts ct (e.g., having relatively large modulus Q) into multiple individual digits (e.g., each having relatively smaller modulus q<Q). For each digit, the homomorphic cryptography circuit may iteratively execute functional bootstrapping (e.g., in Algorithm 4 line 5) to identify the least significant digit from the ciphertexts until only the most significant digit remains. As discussed, functional bootstrapping each smaller modulus digit individually uses a smaller-size LUT for the homomorphic floor function compared to a single relatively large LUT used for the full ciphertext, thereby significantly improving functional bootstrapping efficiency. The homomorphic cryptography circuit may record each digit of the ciphertexts ct (e.g., each of the least significant digits identified by the bootstrapping, and the one remaining most significant digit).

In operation 306, the one or more processor(s) of the second computer may transmit the outputs ct′ of the homomorphic operations of operation 305 back to the first computer terminal or to a different computer terminal (other than the first and second computer terminals, e.g., 110 or another computer downstream of 140, 150, . . . in FIG. 1) to establish cryptographic communication over a communication channel (e.g., of network 120 of FIG. 1 or another network).

In operation 307, the one or more processor(s) of the first computer or the third computer may receive and decrypt the output(s) ct′ using one or more decryption key(s) to output unencrypted homomorphic operation(s) on the plaintext message(s) ƒ(m) (with no access to the unencrypted plaintext message(s) m).

Other operations or orders of operations may be used.

In the foregoing description, various aspects of the present invention are described. For purposes of explanation, specific configurations and details are set forth in order to provide a thorough understanding of the present invention. However, it will also be apparent to persons of ordinary skill in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The aforementioned flowchart and block diagrams illustrate the architecture, functionality, and operation of possible implementations of systems and methods according to various embodiments of the present invention. In this regard, each block in the flowchart or block diagrams may represent one or more data structures, memory locations or portions of code, which may comprise one or more executable instructions for implementing the specified logical function(s). In some alternative implementations, the functions noted in the block may occur out of the order noted in the figures or by different modules. Unless explicitly stated, the method embodiments described herein are not constrained to a particular order or sequence. Additionally, some of the described method embodiments or elements thereof can occur or be performed at the same point in time. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments of the invention may include an article such as a non-transitory computer or processor readable medium, or a computer or processor non-transitory storage medium, such as for example a memory (e.g., memory units 118, 148 or 158 of FIG. 1), a disk drive, or a USB flash memory, encoding, including or storing instructions, e.g., computer-executable instructions, which, when executed by one or more processor(s) or controller(s) (e.g., processor(s) 116, 146 or 156 of FIG. 1), carry out methods disclosed herein.

In the above description, an embodiment is an example or implementation of the inventions. The various appearances of “one embodiment,” “an embodiment” or “some embodiments” do not necessarily all refer to the same embodiments. Although various features of the invention may be described in the context of a single embodiment, the features of embodiments may also be provided separately or in any suitable combination. Conversely, although the invention may be described herein in the context of separate embodiments for clarity, the invention may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

The descriptions, examples, methods and materials presented in the claims and the specification are not to be construed as limiting but rather as illustrative only. While certain features of the present invention have been illustrated and described herein, many modifications, substitutions, changes, and equivalents may occur to those of ordinary skill in the art. It is, therefore, to be understood that the appended claims are intended to cover all such modifications and changes as fall with the true spirit of the invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Different embodiments are disclosed herein. Features of certain embodiments may be combined with features of other embodiments; thus certain embodiments may be combinations of features of multiple embodiments.

1. A method of establishing cryptographic communications between a first computer terminal and a second computer terminal comprising:
receiving, at the second computer terminal, one or more ciphertexts of one or more plaintext messages encrypted under an FHE-LWE scheme by the first computer terminal;
executing, at the second computer terminal, a homomorphic cryptography circuit performing homomorphic operations on the ciphertexts that evaluates a non-linear operation over the encryption of the plaintext messages using one or more lookup table (LUTs) under a functional bootstrapping scheme, wherein the homomorphic cryptography circuit performs functional bootstrapping by executing the LUTs using Nth-order trigonometric Hermite interpolation with derivative constraints set to reduce noise for a set of a plurality of interpolation points; and
transmitting, at the second computer terminal, outputs of the homomorphic operations performed on the ciphertexts back to the first computer terminal or to a different computer terminal over a communication channel.

2. The method of claim 1 wherein the homomorphic cryptography circuit uses a vector data structure to amortize the functional bootstrapping by performing the trigonometric Hermite interpolation over a vector of a plurality of the ciphertexts in parallel.

3. The method of claim 2 comprising executing a Single-Instruction-Multiple-Data (SIMD) instruction to perform the trigonometric Hermite interpolation over the vector of ciphertexts in parallel.

4. The method of claim 1 wherein the derivative constraints comprise Nth order constraints to set the 1-Nth derivatives of the set of the plurality of interpolation points to zero.

5. The method of claim 4, wherein the first-order trigonometric Hermite interpolation with a first-order constraint that sets the first derivatives of the interpolation at the set of the plurality of interpolation points to zero is of the following or equivalent form:
$$R ( x ) = {\sum }_{l = 0}^{p - 1} f ( l ) \cdot U ( 2 π ( x - \frac{l}{p} ) ) , where$$
$$U ( x ) = \frac{1}{p} ( 1 + \frac{2}{p} {\sum }_{k = 1}^{p - 1} ( p - k ) cos ( kx ) ) ,$$
ƒ(l) is an interpolated function at point l and x is a real number between 0 and 1, to derive the fractional values 0, 1/p, 2/p, . . . , (p−2)/p, (p−1)/p, corresponding to p nodes at the set of the plurality of interpolation points and their proximity.

6. The method of claim 4, wherein the second-order trigonometric Hermite interpolation with a second-order constraint that sets the first and second derivatives of the interpolation at the set of the plurality of interpolation points to zero is of the following or equivalent form:
$${R}_{2} ( x ) = {\sum }_{l = 0}^{p - 1} f ( l ) \cdot {U}_{2} ( 2 π ( x - \frac{l}{p} ) ) , where$$
$${U}_{2} ( x ) = U ( x ) + \frac{1 - cos ( p x )}{{p}^{3}} {\sum }_{k = 1}^{⌊ p / 2 ⌋} ( 2 - {γ}_{p , k} ) k ( p - k ) cos ( k x ) ,$$
γ_{p,k}=1 if p is even and k=p/2, and γ_{p,k}=0 otherwise.

7. The method of claim 4, wherein the third-order trigonometric Hermite interpolation with a third-order constraint that sets the first, second and third derivatives of the interpolation at the set of the plurality of interpolation points to zero is of the following or equivalent form:
$${R}_{3} ( x ) = {\sum }_{l = 0}^{p - 1} f ( l ) \cdot {U}_{3} ( 2 π ( x - \frac{l}{p} ) ) , where$$
$${U}_{3} ( x ) = U ( x ) + \frac{2 ( 1 - cos ( p x ) )}{3 {p}^{4}} {\sum }_{k = 1}^{p - 1} k ( p - k ) ( 2 p - k ) cos ( k x ) .$$

8. The method of claim 1 wherein the homomorphic cryptography circuit executes functional bootstrapping to evaluate multi-precision sign evaluation comprising:
breaking down the ciphertexts into multiple digits;
for each digit, iteratively executing the functional bootstrapping to clear the least significant digit from the ciphertexts until only the most significant digit remains; and
executing the functional bootstrapping on the remaining most significant digit to evaluate the sign function of the ciphertexts.

9. The method of claim 1 wherein the homomorphic cryptography circuit executes functional bootstrapping to evaluate multi-precision digit extraction comprising:
breaking down the ciphertexts into multiple digits;
for each digit, iteratively executing the functional bootstrapping to identify the least significant digit from the ciphertexts until only the most significant digit remains; and
recording each digit of the ciphertexts.

10. The method of claim 1 comprising:
receiving or retrieving the one or more plaintext messages at the first computer terminal;
transforming the plaintext messages at the first computer terminal using an encryption key to produce the ciphertexts of the plaintext message; and
transmitting the ciphertexts to the second computer terminal over a communication channel.

11. The method of claim 1 comprising:
receiving the outputs of the homomorphic operations performed on the ciphertexts at the first or different computer terminal over a communication channel; and
decrypting the outputs to output an unencrypted version of the homomorphic operations on the plaintext message(s) with no access to the unencrypted plaintext message(s).

12. A second computer terminal establishing cryptographic communications with a first computer terminal, the second computer terminal comprising:
one or more memories configured to store one or more ciphertexts of one or more plaintext messages encrypted under an FHE-LWE scheme by the first computer terminal; and
one or more processors configured to:
execute a homomorphic cryptography circuit performing homomorphic operations on the ciphertexts that evaluates a non-linear operation over the encryption of the plaintext messages using one or more lookup table (LUTs) under a functional bootstrapping scheme, wherein the homomorphic cryptography circuit performs functional bootstrapping by executing the LUTs using Nth-order trigonometric Hermite interpolation with derivative constraints set to reduce noise for a set of a plurality of interpolation points, and
transmit outputs of the homomorphic operations performed on the ciphertexts back to the first computer terminal or to a different computer terminal over a communication channel.

13. The second computer terminal of claim 12, wherein the one or more processors are configured to execute the homomorphic cryptography circuit using a vector data structure to amortize the functional bootstrapping by performing the trigonometric Hermite interpolation over a vector of a plurality of the ciphertexts in parallel.

14. The second computer terminal of claim 13, wherein the one or more processors are configured to execute a Single-Instruction-Multiple-Data (SIMD) instruction to perform the trigonometric Hermite interpolation over the vector of ciphertexts in parallel.

15. The second computer terminal of claim 12, wherein the derivative constraints comprise Nth order constraints to set the 1-Nth derivatives of the set of the plurality of interpolation points to zero.

16. The second computer terminal of claim 12, wherein the one or more processors are configured to execute the homomorphic cryptography circuit by performing functional bootstrapping to evaluate multi-precision sign evaluation comprising:
breaking down the ciphertexts into multiple digits,
for each digit, iteratively executing the functional bootstrapping to clear the least significant digit from the ciphertexts until only the most significant digit remains, and
executing the functional bootstrapping on the remaining most significant digit to evaluate the sign function of the ciphertexts.

17. The second computer terminal of claim 12, wherein the one or more processors are configured to execute the homomorphic cryptography circuit by performing functional bootstrapping to evaluate multi-precision digit extraction comprising:
breaking down the ciphertexts into multiple digits,
for each digit, iteratively executing the functional bootstrapping to identify the least significant digit from the ciphertexts until only the most significant digit remains, and
recording each digit of the ciphertexts.

18. A system comprising the second computer terminal of claim 12 and further comprising the first computer terminal, wherein the first computer terminal comprises one or more processors configured to:
receive or retrieve the one or more plaintext messages at the first computer terminal,
transform the plaintext messages at the first computer terminal using an encryption key to produce the ciphertexts of the plaintext message, and
transmit the ciphertexts to the second computer terminal over a communication channel.

19. A system comprising the second computer terminal of claim 12 and further comprising the first computer terminal or different computer terminal, wherein the first computer terminal or the different computer terminal comprises one or more processors configured to:
receive the outputs of the homomorphic operations performed on the ciphertexts at the first or different computer terminal over a communication channel, and
decrypt the outputs to output an unencrypted version of the homomorphic operations on the plaintext message(s) with no access to the unencrypted plaintext message(s).

20. The second computer terminal of claim 12, wherein the functional bootstrapping scheme is Cheon-Kim-Kim-Song (CKKS), Brakerski/Fan-Vercauteren (BFV), or Ring-Gentry-Sahai-Waters (RGSW).
